(19) United States
(12) Patent Application Publication
(10) Pub. No.: US 2014/0052585 A1
(43) Pub. Date: Feb. 20, 2014

(54) INFORMATION PROCESSING SYSTEM, INFORMATION PROCESSING METHOD, PROGRAM, AND INFORMATION RECORDING MEDIUM

(71) Applicant: Isao Ito, Shinagawa-ku (JP)

(72) Inventor: Isao Ito, Shinagawa-ku (JP)

(73) Assignee: RAKUTEN, INC., Shinagawa-ku, Tokyo (JP)

(21) Appl. No.: 14/113,581

(22) PCT Filed: Jan. 5, 2012
(86) PCT No.: PCT/JP2012/050107

§ 371 Date: Oct. 24, 2013

(30) Foreign Application Priority Data
Apr. 28, 2011 (JP) 2011-102527

(51) Int. Cl. G06Q 30/06

(52) U.S. Cl. CPC G06Q 30/0635
USPC 705/26.81

(57) ABSTRACT

Order-taking situations in a shop and other shops located in the same region are compared, thereby setting features that are not recognized by the shop. A shop information providing server (500) sequentially stores a shop ID, a menu ID, and an order quantity of a menu in a database. The shop information providing server (500) extracts shops located in a set region, refers to the database, identifies, for the extracted shops, product information having the order quantity relatively larger than those of the other shops, and sets information on the identified product as attribute information on the shop ID.

### TECHNICAL FIELD

The present invention relates to an information processing system, an information processing method, a program, and an information recording medium.

### BACKGROUND ART

There is a system for searching shops such as restaurants registered in advance for an appropriate shop based on a search query received from a user to provide the user with information on the retrieved shop. For example, in Patent Literature 1, there is disclosed a system for setting in advance a selling point (feature) for each shop based on a list of products provided by the shop as attribute information, extracting the shop to which the attribute information specified in the search query received from the user is set, and providing the user with the information on the extracted shop.

### CITATION LIST

### Patent Literature

[Patent Literature 1] JP 2011-014035 A

### SUMMARY OF INVENTION

### Technical Problem

However, with the conventional technology, the shop needs to set in advance the attribute information recognized by itself as the feature, and hence even if the shop has such a feature that attracts customers, the feature cannot be set as the attribute information unless the shop recognizes the feature as the attribute information.

The present invention has been made in view of the above-mentioned problem, and has an object to provide an information processing system, an information processing method, a program, and an information recording medium that enable setting, as attribute information, a feature that is not recognized by a shop as the attribute information.

### Solution to Problem

In order to set the above-mentioned object, an information processing system according to the present invention includes: extracting means for extracting, from shop information storage means for storing a location of a shop in association with shop identification information for identifying the shop, a plurality of pieces of the shop identification information indicating the shops located in a given region; order record information acquisition means for acquiring, from order record information storage means for storing order record information including the shop identification information, product identification information for identifying a product ordered in the shop indicated by the shop identification information, and an order quantity of the product, a plurality of pieces of the order record information associated with the plurality of pieces of the shop identification information extracted by the extracting means; and setting means for identifying, based on the plurality of pieces of the order record information acquired by the order record information acquisition means, the shop identification information of the shop having an evaluation value, which represents a magnitude of the order quantity of one or a plurality of the products common in a product classification, relatively larger than the evaluation values of other shops located in the given region, and setting information on the product classification as attribute information on the shop in association with the identified shop identification information.

According to one aspect of the present invention, in the information processing system, the order record information includes information on a user relating to the order record information, the order record information acquisition means acquires, from the order record information storage means, the plurality of pieces of the order record information that are associated with the plurality of pieces of the shop identification information extracted by the extracting means, and are common in the information on the user, and the setting means identifies, based on the plurality of pieces of the order record information acquired by the order record information acquisition means, the shop identification information of the shop having the evaluation value, which represents the magnitude of the order quantity of the one or the plurality of the products common in the product classification, relatively larger than the evaluation values of the other shops located in the given region, and sets the information on the product classification and the information on the user as the attribute information on the shop in association with the identified shop identification information.

According to one aspect of the present invention, the information processing system further includes: search means for searching the plurality of pieces of the shop identification information located in a position of a user terminal or in a region set by a specification for the shop identification information having the information on the product classification, which is identified based on a search query received from the user terminal, set as the attribute information; and providing means for providing the user terminal with information on the shop identified by the shop identification information retrieved by the search means.

According to one aspect of the present invention, the information processing system further includes: search means for searching the plurality of pieces of the shop identification information located in a position of a user terminal or in a region set by a specification for the shop identification information having the information on the product classification, which is identified based on a search query received from the user terminal and information on a user relating to the user terminal, set as the attribute information; and providing means for providing the user terminal with information on the shop identified by the shop identification information retrieved by the search means.

According to one aspect of the present invention, the information processing system further includes providing means for providing, when an information providing request for requesting information on the shop is received from a user terminal, the information on the shop by adding thereto the information on the product classification set by the setting means in association with the shop identification information of the shop.

According to one aspect of the present invention, the information processing system further includes changing means for changing a size of the given region based on a number of the plurality of pieces of the shop identification information extracted by the extracting means.

According to one aspect of the present invention, the information processing system further includes changing means for changing a size of the given region when the attribute information is not set by the setting means to a predetermined number or predetermined ratio of pieces of the shop identification information among the plurality of pieces of the shop identification information extracted by the extracting means.

According to one aspect of the present invention, the information processing system further includes calculating means for calculating a deviation value of the order quantity of the one or the plurality of the products common in the product classification ordered in the each of the shops based on the plurality of pieces of the order record information acquired by the order record information acquisition means, for each of the shops located in the given region, and the setting means sets the information on the product classification as the attribute information to the shop having the deviation value calculated by the calculating means that is a predetermined value or larger, or larger than the predetermined value.

According to one aspect of the present invention, the information processing system further includes calculating means for calculating an average value of the order quantity of the one or the plurality of the products common in the product classification ordered in a plurality of the shops located in the given region based on the plurality of pieces of the order record information acquired by the order record information acquisition means, and the setting means sets the information on the product classification as the attribute information to the shop having the order quantity of the one or the plurality of the products common in the product classification that is larger than the average value calculated by the calculating means by a predetermined value or larger, or a value larger than the predetermined value.

According to one aspect of the present invention, the evaluation value representing the magnitude of the order quantity of the one or the plurality of the products common in the product classification is calculated based on any one of the order quantity of the one or the plurality of the products, a ratio of the order quantity of the one or the plurality of the products to a total of the order quantity received by the shop, and an order repeat count of the same user of the one or the plurality of the products, or based on a combination thereof.

An information processing method according to the present invention includes: an extracting step of extracting, from shop information storage means for storing a location of a shop in association with shop identification information for identifying the shop, a plurality of pieces of the shop identification information indicating the shops located in a given region; an order record information acquisition step of acquiring, from order record information storage means for storing order record information including the shop identification information, product identification information for identifying a product ordered in the shop indicated by the shop identification information, and an order quantity of the product, a plurality of pieces of the order record information associated with the plurality of pieces of the shop identification information extracted in the extracting step; and a setting step of identifying, based on the plurality of pieces of the order record information acquired in the order record information acquisition step, the shop identification information of the shop having an evaluation value, which represents a magnitude of the order quantity of one or a plurality of the products common in a product classification, relatively larger than the evaluation values of other shops located in the given region, and setting information on the product classification as attribute information on the shop in association with the identified shop identification information.

A program according to the present invention causes a computer to function as: extracting means for extracting, from shop information storage means for storing a location of a shop in association with shop identification information for identifying the shop, a plurality of pieces of the shop identification information indicating the shops located in a given region; order record information acquisition means for acquiring, from order record information storage means for storing order record information including the shop identification information, product identification information for identifying a product ordered in the shop indicated by the shop identification information, and an order quantity of the product, a plurality of pieces of the order record information associated with the plurality of pieces of the shop identification information extracted by the extracting means; and setting means for identifying, based on the plurality of pieces of the order record information acquired by the order record information acquisition means, the shop identification information of the shop having an evaluation value, which represents a magnitude of the order quantity of one or a plurality of the products common in a product classification, relatively larger than the evaluation values of other shops located in the given region, and setting information on the product classification as attribute information on the shop in association with the identified shop identification information.

An information recording medium according to the present invention has recorded thereon a program for causing a computer to function as: extracting means for extracting, from shop information storage means for storing a location of a shop in association with shop identification information for identifying the shop, a plurality of pieces of the shop identification information indicating the shops located in a given region; order record information acquisition means for acquiring, from order record information storage means for storing order record information including the shop identification information, product identification information for identifying a product ordered in the shop indicated by the shop identification information, and an order quantity of the product, a plurality of pieces of the order record information associated with the plurality of pieces of the shop identification information extracted by the extracting means; and setting means for identifying, based on the plurality of pieces of the order record information acquired by the order record information acquisition means, the shop identification information of the shop having an evaluation value, which represents a magnitude of the order quantity of one or a plurality of the products common in a product classification, relatively larger than the evaluation values of other shops located in the given region, and setting information on the product classification as attribute information on the shop in association with the identified shop identification information.

### Advantageous Effects of Invention

According to one aspect of the present invention, the feature that is not recognized by the shop can be set as the attribute information.

### BRIEF DESCRIPTION OF DRAWINGS

FIG. 1 is a system configuration diagram of a shop information processing system according to an embodiment of the present invention.

FIG. 2 is a diagram illustrating menu categories.

FIG. 3 is a sequence diagram of order processing performed in the shop information processing system.

FIG. 4 is a diagram illustrating an example of a menu screen.

FIG. 5 is a diagram illustrating an example of a menu order screen.

FIG. 6 is a diagram illustrating an example of a payment start email.

FIG. 7 is a diagram illustrating an example of an electronic money payment start screen.

FIG. 8 is a diagram illustrating an example of a payment completion email.

FIG. 9 is a flowchart of shop feature detecting processing.

FIG. 10 is a sequence diagram of shop information providing processing.

FIG. 11 is a diagram illustrating an example of a shop search screen.

FIG. 12 is a diagram illustrating an example of a shop information display screen.

FIG. 13 is a functional block diagram of a mobile terminal.

FIG. 14 is a functional block diagram of an order receiving server.

FIG. 15 is a table showing an example of a user information table.

FIG. 16 is a table showing an example of a menu information table.

FIG. 17 is a functional block diagram of a payment server.

FIG. 18 is a functional block diagram of a shop information providing server.

FIG. 19 is a table showing an example of an order history table.

FIG. 20 is a table showing an example of a shop feature information table.

FIG. 21 is a table showing an example of the menu information table.

FIG. 22 is a table showing an example of a user classification information table.

### DESCRIPTION OF EMBODIMENT

Now, an embodiment mode of the present invention (hereinafter referred to as “embodiment”) is described with reference to the drawings.

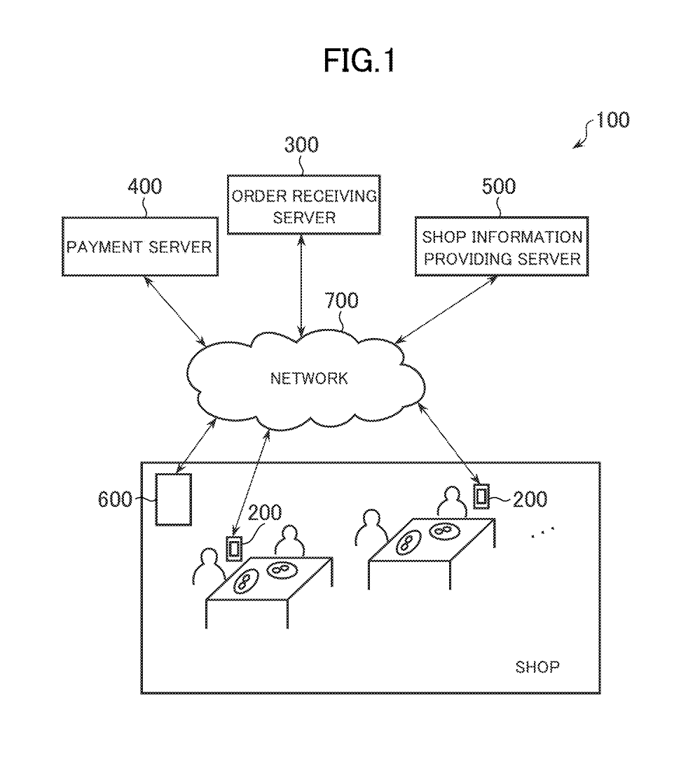

FIG. 1 illustrates a system configuration diagram of a shop information processing system 100 according to this embodiment.

As illustrated in FIG. 1, the shop information processing system 100 includes a mobile terminal 200, an order receiving server 300, a payment server 400, a shop information providing server 500, and a shop terminal 600. The mobile terminal 200, the order receiving server 300, the payment server 400, the shop information providing server 500, and the shop terminal 600 are communicably connected to one another via a network 700.

The mobile terminal 200 is an information processing terminal having a wireless communication function and a payment function by electronic money or the like. For example, the mobile terminal 200 includes an operation receiving unit such as a touch panel and buttons, and executes processing in response to an operation received from a user and displays a result of the processing on the touch panel. For example, the user performs the following processing. Specifically, the user downloads menu information indicating menus served by a shop from the order receiving server 300 by using the mobile terminal 200, places an order of a specified menu from the menu information, and executes electronic payment on the ordered menu between the mobile terminal 200 and the payment server 400. Note that, the shop to be used for the description of this embodiment is a restaurant.

The order receiving server 300 is a server that receives order information from the mobile terminal 200 and processes the received order information. For example, the order receiving server 300 requests the payment server 400 to execute electronic payment on the order information received from the mobile terminal 200, and when receiving a completion notification of the electronic payment from the payment server 400, transmits the order information to the shop terminal 600. Note that, the shop serves the menu ordered by the user in the shop based on the order information received by the shop terminal 600 from the order receiving server 300.

The payment server 400 is a server that causes the mobile terminal 200 that has transmitted the order information to execute the electronic payment on the order information received by the order receiving server 300 from the mobile terminal 200, and obtains and manages a result of the execution. For example, the payment server 400 causes the mobile terminal 200 to execute electronic money payment on the order information generated by the mobile terminal 200, and when the electronic money payment is successfully completed, transmits a payment completion notification on the order information to the order receiving server 300.

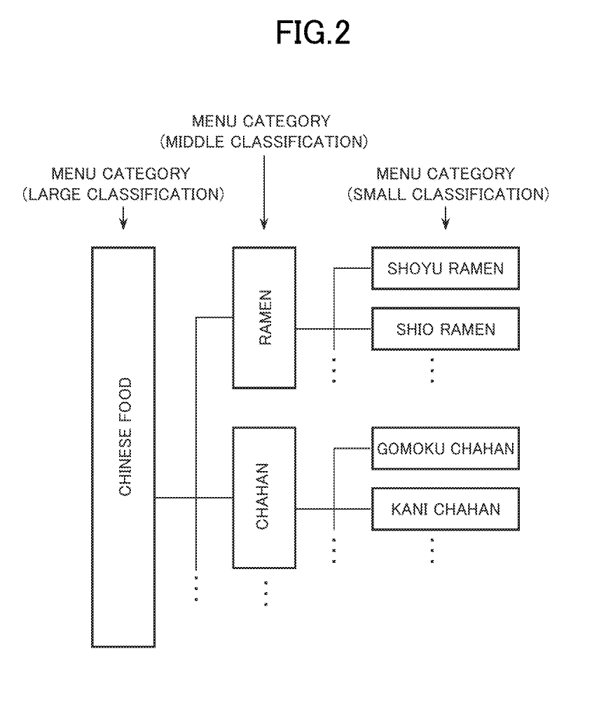

For example, the shop information providing server 500 compares, based on the order information of the user received from the order receiving server 300, pieces of the order information relating to a menu category of the respective shops located in the same area with one another, determines the shop satisfying a predetermined condition for the menu category as the shop having a feature in the menu category, and assigns the determined shop with attribute information including information on the area and the menu category. Note that, the menu category is a classification to which one or a plurality of menus belong. FIG. 2 is a diagram illustrating the menu categories. As illustrated in FIG. 2, for example, the menu categories may have a hierarchical structure having a large classification, a middle classification, and a small classification (such as the menu itself). To be specific, menu categories “shoyu ramen (Chinese-style noodles with a soy-sauce based broth)” and “shio ramen (Chinese-style noodles with a salt-based broth)” belong to a menu category “ramen (Chinese-style noodles)”, and menu categories “gomoku chahan (Chinese-style fried rice with scrambled egg, onion, carrot, bamboo shoots, pork, etc.)” and “kani chahan (Chinese-style fried rice with crab meat)” belong to a menu category “chahan (Chinese-style fried rice)”. Moreover, the menu category may belong to a higher-level menu category. For example, the menu categories “ramen” and “chahan” belong to a higher-level menu category “Chinese food”. Note that, in an example to be described below, lowest-level menu categories among the menu categories are each referred to as “menu”.

Further, for example, the shop information providing server 500 sets search conditions relating to the area and the menu category based on shop search queries received from a user terminal, searches for the shop based on the set search conditions and the attribute information assigned to the shop, and provides the user terminal with information on the retrieved shop.

[Example of Sequence of Order Processing in Shop Information Processing System 100]

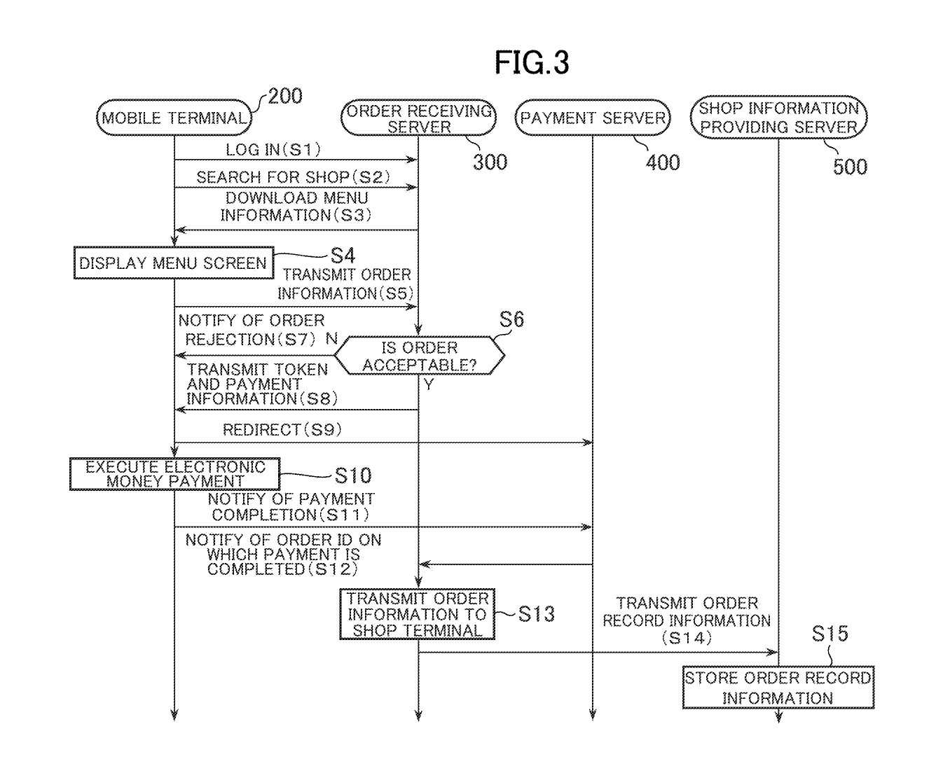

In the following, referring to a sequence diagram illustrated in FIG. 3, a flow of order processing performed in the shop information processing system 100 is described. In a sequence to be described below, processing in which the user orders the menu in the restaurant is taken as an example. Note that, it is assumed that in this sequence, the user registers in the order receiving server 300 attribute information including his/her user ID, email address, sex, and date of birth in advance.

As illustrated in FIG. 3, the user inputs the user ID and a password by using the mobile terminal 200 to log in to the order receiving server 300 in a shop to be used or outside the shop (S1), searches for the shop to be used (S2), and downloads the menu information on the retrieved shop (S3). Note that, along with the menu information, the mobile terminal 200 may download an application for performing processing of placing the order to the order receiving server 300 based on the menu information.

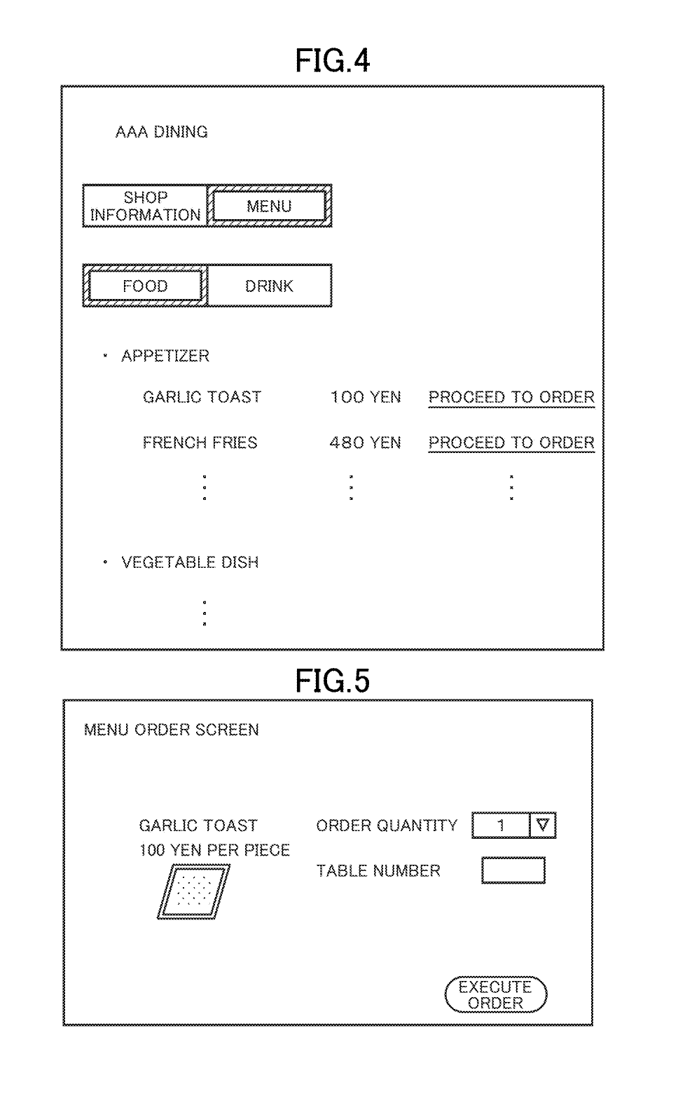

The mobile terminal 200 displays a menu screen based on the downloaded menu information (S4). FIG. 4 illustrates an example of the menu screen displayed on the mobile terminal 200. In the example of the menu screen illustrated in FIG. 4, a name of a menu, a price of the menu, and a link for proceeding to the order of the menu are provided for each menu.

When the link of “PROCEED TO ORDER” is pressed, a menu order screen illustrated in FIG. 5 is displayed, for example. In the menu order screen illustrated in FIG. 5, an order quantity, an input field for table identification information for identifying a table of the user (such as table number), a link of “EXECUTE ORDER” for executing the order, and the like are provided.

After the user is guided to the table in the shop, for example, when the user inputs the order quantity and the table identification information of the table to the menu order screen illustrated in FIG. 5 and then presses the link of “EXECUTE ORDER”, the mobile terminal 200 transmits to the order receiving server 300 the order information including the menu and the order quantity requested by the user, the table identification information, a shop ID, and the user ID (S5).

When the order relating to the order information received from the mobile terminal 200 is unacceptable (S6: N), the order receiving server 300 transmits an order rejection notification to the mobile terminal 200 (S7). When the order relating to the order information received from the mobile terminal 200 is acceptable (S6: Y), the order receiving server 300 transmits payment information on the order information and a token of the payment information to the mobile terminal 200 (S8), and redirects the mobile terminal 200 to the payment server 400 as well (S9). Note that, the order receiving server 300 may make an inquiry to the shop terminal 600 to determine whether or not the order is acceptable. Alternatively, in a case where the order receiving server 300 retains information on the menus for which the order is acceptable for each shop while sequentially updating the information, the order receiving server 300 may determine whether or not the order is acceptable based on the information on the menus for which the order is acceptable.

Note that, the order receiving server 300 may transmit to the payment server 400 payment request information including an order ID for identifying the order information, a payment amount, the user's email address relating to the order information. In this case, the payment server 400 may transmit a payment start email including a link for executing the electronic payment to the email address included in the payment request information received from the order receiving server 300.

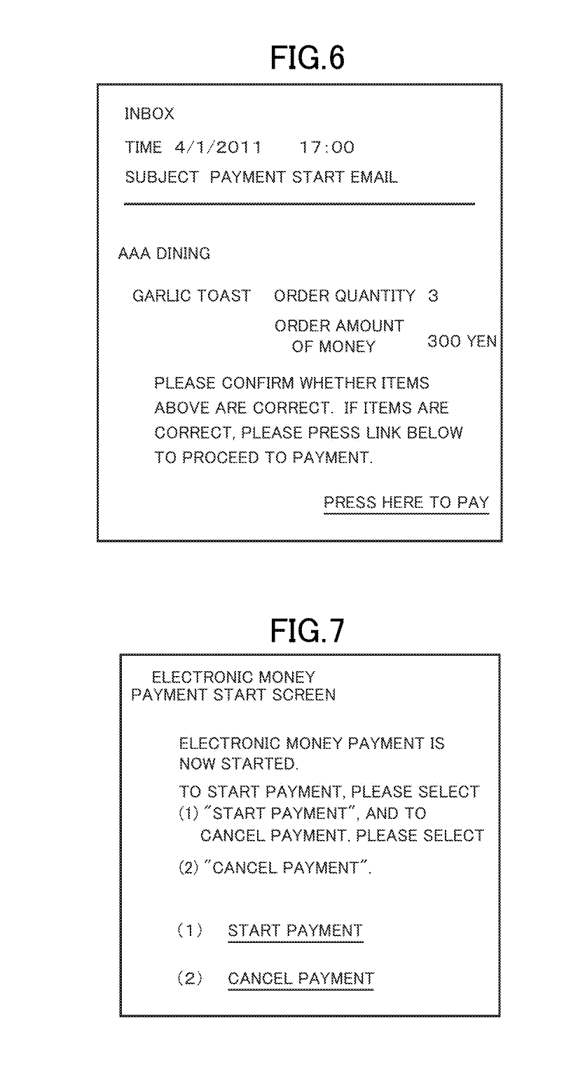

FIG. 6 illustrates an example of the payment start email. In the example illustrated in FIG. 6, the payment start email includes details of the order relating the payment (menu, the order quantity, and the payment amount) and a link of “PRESS HERE TO PAY”. When the link of “PRESS HERE TO PAY” is selected, the screen proceeds to, for example, an electronic money payment start screen illustrated in FIG. 7 so that the user follows a guidance of the electronic money payment start screen to execute the electronic money payment.

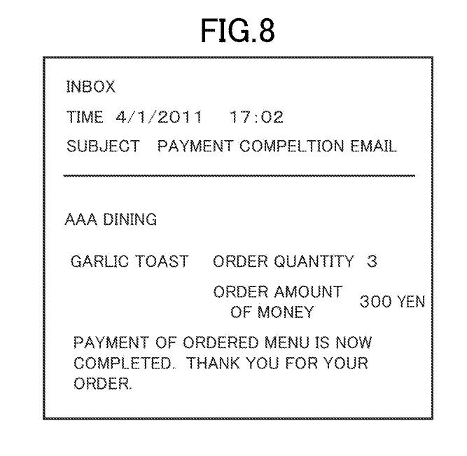

When the mobile terminal 200 communicates to/from the payment server 400 to execute the electronic money payment based on the payment information (S10), the payment server 400 receives a completion notification of the electronic money payment (S11), and transmits, for example, a payment completion email illustrated in FIG. 8 to the mobile terminal 200.

The payment server 400 notifies the order receiving server 300 of information on the order ID on which the electronic money payment is completed (S12), and the order receiving server 300 transmits to the shop terminal 600 the order information relating to the order ID for which the payment completion notification is received (S13). In the shop, food and drink relating to the menu ordered by the user are served based on the order information received by the shop terminal 600 from the order receiving server 300.

The order receiving server 300 transmits to the shop information providing server 500 order record information relating to the order information that has been processed (S14). For example, the order record information may include the order ID, the user ID, the shop ID, a menu ID, the order quantity, an order time, and the like. The order receiving server 300 may transmit the order record information relating to the order information to the shop information providing server 500 each time processing on the order information is completed, or may transmit, at a predetermined timing (for example, every predetermined time interval), pieces of the order record information that have been accumulated until that time and are not transmitted yet to the shop information providing server 500. The shop information providing server 500 stores the order record information received from the order receiving server 300 (S15). The processing described above (S5 to S15) may be performed each time the order is received from the mobile terminal 200.

Note that, the sequence of the order processing in the shop information processing system 100 is not limited to the example described above. For example, in the above-mentioned sequence, when the order relating to the order information received from the mobile terminal 200 is acceptable (S6: Y), the order receiving server 300 may issue the token and then transmit the issued token to the payment server 400, and the payment server 400 may transmit the payment information including the token to the mobile terminal 200. In this case, after the payment is executed on the mobile terminal 200, the mobile terminal 200 transmits a payment completion notification including the token to the order receiving server 300, and the order receiving server 300 compares the token included in the payment completion notification with the issued token for verification to determine the order information on which the payment is completed. Alternatively, after the payment is executed on the mobile terminal 200, the mobile terminal 200 may transmit the payment completion notification including the token to the payment server 400, and the order receiving server 300 may receive the token from the payment server 400 to compare the received token with the issued token for verification.

A description is now given of details of shop feature detecting processing performed by the shop information providing server 500.

[Example of Shop Feature Detecting Processing]

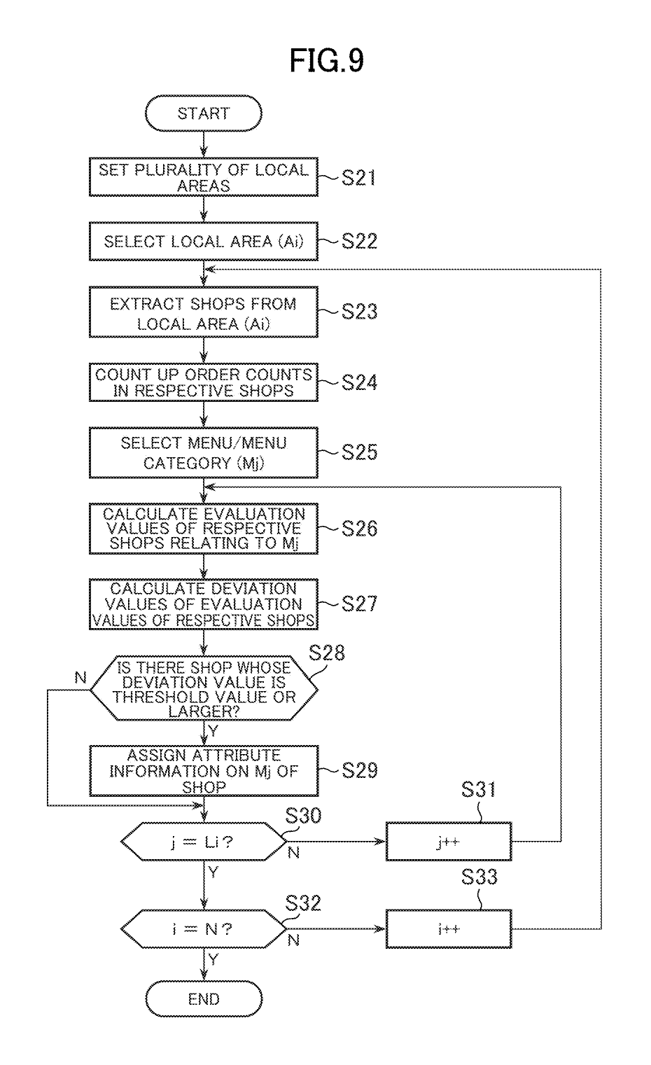

FIG. 9 illustrates an example of a flowchart of the shop feature detecting processing performed by the shop information providing server 500. The shop feature detecting processing described below is to be performed on the restaurant, and is an example of processing of detecting a characteristic menu/menu category in the restaurant.

As illustrated in FIG. 9, the shop information providing server 500 sets a plurality of local areas (Ai, 1≦i≦N, where N represents a total count of local areas) in a target area (S21), and selects one of the local areas (Ai, an initial value of i being one (1)) (S22). The shop information providing server 500 extracts the shops that satisfy a predetermined condition (such as the shop belonging to a predetermined category) from the selected local area (Ai) (S23).

Based on the order record information relating to the respective extracted shops, the shop information providing server 500 counts up order counts during a predetermined period in the respective shops for each menu/menu category (S24).

The shop information providing server 500 selects one of menus/menu categories (Mj, 1≦j≦Li, where Li represents a total count of menus/menu categories) (Mi, an initial value of j being one (1)) served by the respective extracted shops (S25), and based on the order counts counted up for the selected menu/menu category (Mj) in the respective shops, calculates evaluation values of the respective shops relating to the selected menu/menu category (Mj) (S26).

The shop information providing server 500 calculates deviation values of the calculated evaluation values of the respective shop (S27), and when there is a shop whose calculated deviation value is a threshold value or larger (S28: Y), assigns the shop with attribute information on the local area (Ai) and the menu/menu category (Mj) (S29). Note that, when there is no shop whose calculated deviation value is the threshold value or larger (S28: N), the processing of the shop information providing server 500 proceeds to S30.

When j is not the total count (Li) of menus/menu categories (S30: N), the shop information providing server 500 increments j (S31), and the processing returns to S26. When j is the total count (Li) of menus/menu categories (S30: Y), the processing proceeds to S32.

When i is not the total count of local areas (N) (S32: N), the shop information providing server 500 increments i (S33), and the processing returns to S23. When i is the total count of local areas (N) (S32: Y), the processing is brought to an end.

[Example of Shop Information Providing Processing]

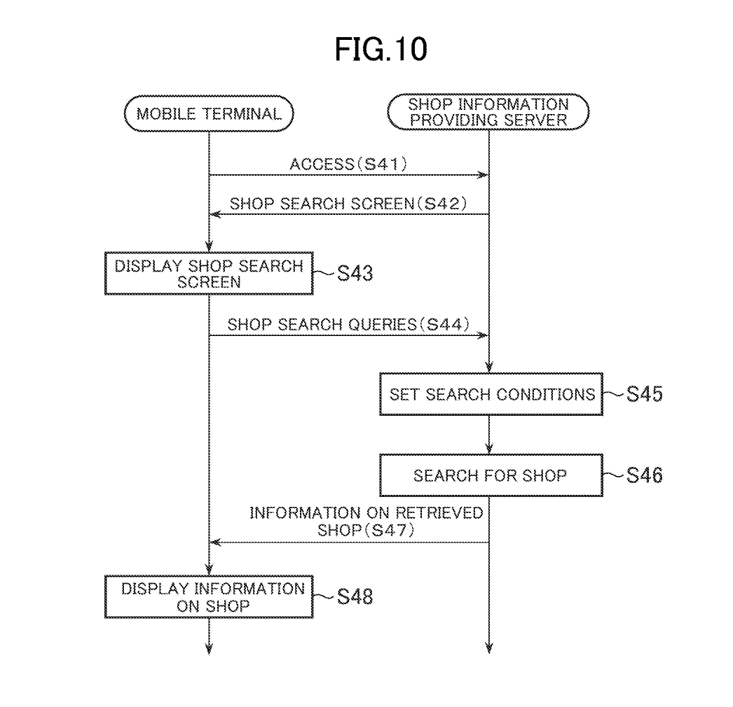

Next, a description is given of an example of shop information providing processing performed by the shop information providing server 500 with reference to a sequence diagram illustrated in FIG. 10.

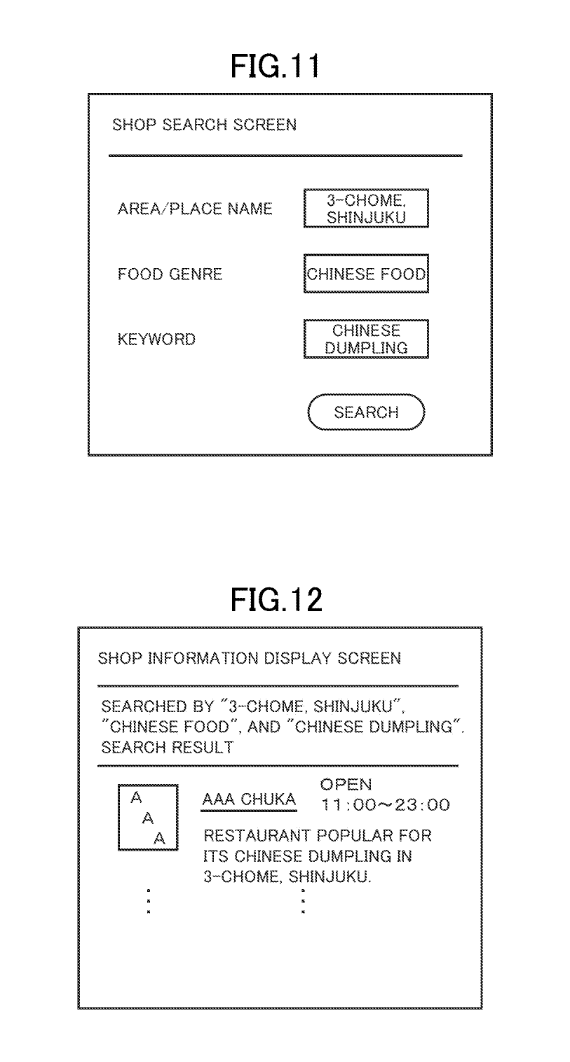

As illustrated in FIG. 10, when the mobile terminal 200 accesses the shop information providing server 500 (S41), for example, display data for displaying a shop search screen illustrated in FIG. 11 is transmitted to the mobile terminal 200 (S42). The mobile terminal 200 displays the shop search screen based on the received display data (S43), and when a “SEARCH” button is pressed after information such as a desired area and menu is input to the displayed shop search screen, the shop search queries are transmitted from the mobile terminal 200 to the shop information providing server 500 (S44).

When receiving the shop search queries from the mobile terminal 200, the shop information providing server 500 sets search conditions specifying conditions for the local area and the menu/menu category based on the shop search queries (S45). The condition for the local area specified in the search condition may be included in the shop search query, or may be set based on positional information on the mobile terminal 200. Further, the condition for the menu/menu category specified in the search condition may be included in the shop search query, or may be set based on a word included in the shop search query.

Based on the set search conditions, the shop information providing server 500 searches for the shop assigned with attributes of the local area and menu/menu category specified in the search conditions (S46), and transmits information on the retrieved shop to the mobile terminal 200 (S47).

Based on the information on the shop received from the shop information providing server 500, the mobile terminal 200 displays, for example, a shop information display screen illustrated in FIG. 12 (S48).

A flow of the series of processing performed in the shop information processing system 100 is described above. Next, a description is given of an example of functions that are provided to the respective devices of the shop information processing system 100 for realizing the sequence described above.

[Functions of Mobile Terminal 200]

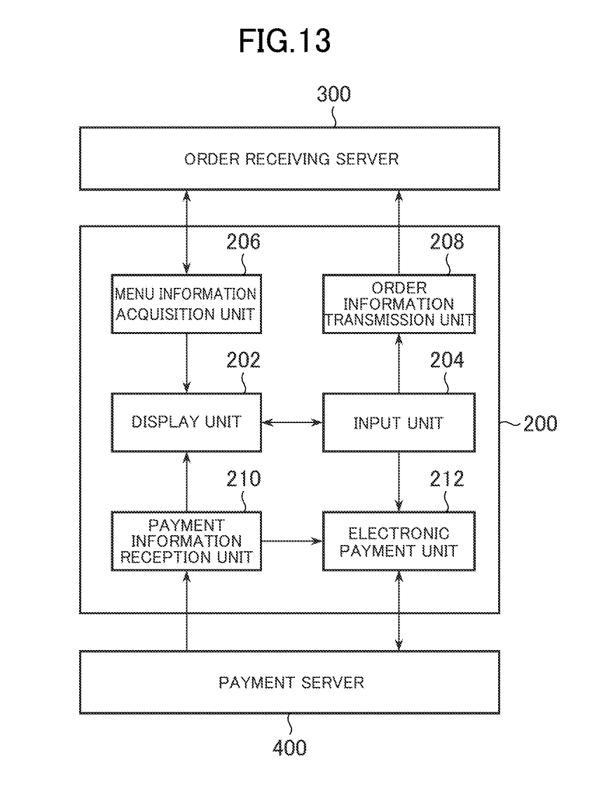

FIG. 13 illustrates a functional block diagram of the mobile terminal 200. As illustrated in FIG. 13, the mobile terminal 200 includes a display unit 202, an input unit 204, a menu information acquisition unit 206, an order information transmission unit 208, a payment information reception unit 210, and an electronic payment unit 212.

Functions of the above-mentioned units provided to the mobile terminal 200 may be realized by a computer, which includes hardware including control means such as a CPU, storage means such as a memory, communication means such as a communication interface for transmitting/receiving data to/from an external device, display means and input means such as the touch panel, and an IC chip for electronic money payment, reading a program stored in a computer-readable information storage medium to execute the program. Note that, the program may be provided to the mobile terminal 200 via the information storage medium such as an optical disc, a magnetic disk, a magnetic tape, a magneto-optical disk, or a flash memory, or may be provided via a data communication network such as the Internet to the mobile terminal 200.

The display unit 202 is realized by, for example, the touch panel, and displays a screen based on graphic data. On the display unit 202, for example, the screens illustrated in FIGS. 4 to 8, FIG. 11, and FIG. 12 are displayed.

The input unit 204 receives an operation input from the user through, for example, the touch panel and buttons.

The menu information acquisition unit 206 accesses, for example, the order receiving server 300 to acquire the menu information on the shop specified based on the input from the input unit 204. Further, along with the menu information, the menu information acquisition unit 206 may acquire and install the application for placing the order to the order receiving server 300 based on the menu information.

The order information transmission unit 208 generates the order information relating to the menu selected from the menu information acquired by the menu information acquisition unit 206 and transmits the generated order information to the order receiving server 300. The menu to be ordered may be selected by following the menu screen displayed on the display unit 202 based on the menu information. Moreover, the order information may include, for example, the user ID, the menu ID, the order quantity, the shop ID, and the table identification information for identifying a seat of the user that relate to the order.

The payment information reception unit 210 receives from the payment server 400 the payment information on the order information transmitted by the order information transmission unit 208. The payment information is information for starting the electronic payment, and may include, for example, the order information relating to the payment and the payment amount. In this embodiment, the mobile terminal 200 executes the electronic payment by electronic money, but may execute other types of electronic payment such as a credit card payment.

The electronic payment unit 212 executes the electronic payment based on the payment information received by the payment information reception unit 210. Note that, when the electronic payment by electronic money is executed, the payment amount relating to the payment information is subtracted from a balance of the electronic money retained in the mobile terminal 200. When the balance is the payment amount or more, the electronic payment is completed successfully, and when the balance is less than the payment amount, an error occurs. In addition, the mobile terminal 200 notifies the payment server 400 of a result of the electronic payment executed by the electronic payment unit 212.

[Functions of Order Receiving Server 300]

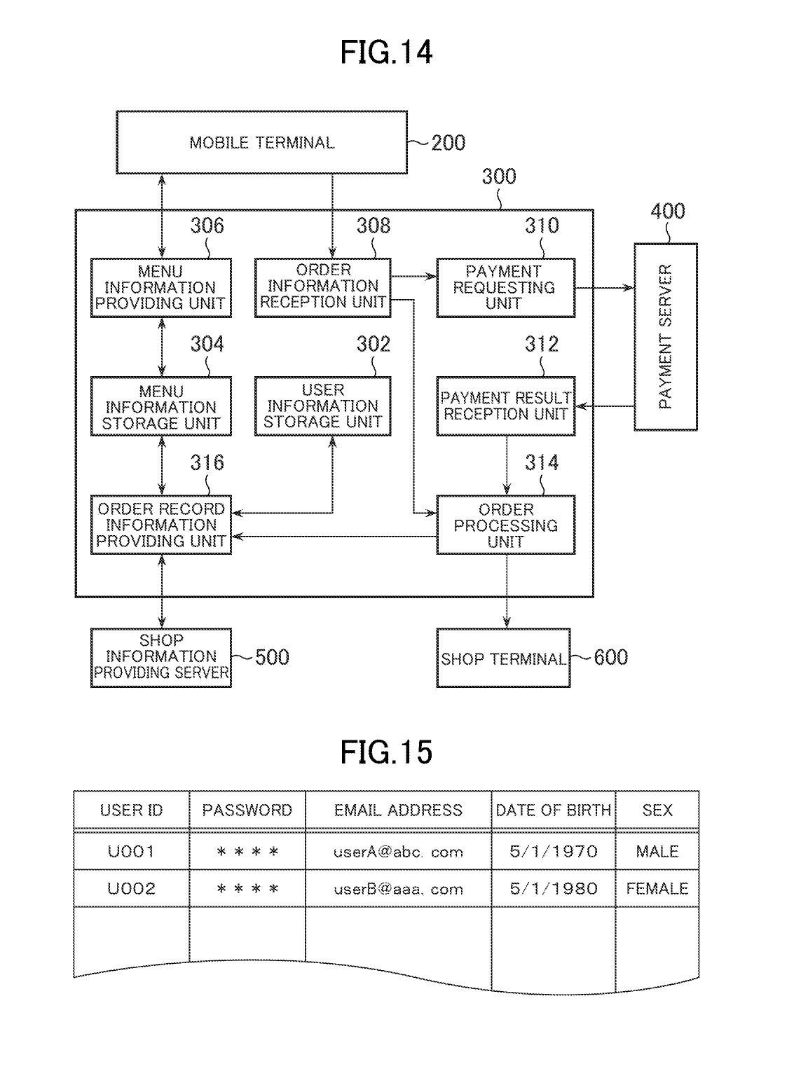

Next, a description is given of functions provided to the order receiving server 300. FIG. 14 illustrates a functional block diagram of the order receiving server 300. As illustrated in FIG. 14, the order receiving server 300 includes a user information storage unit 302, a menu information storage unit 304, a menu information providing unit 306, an order information reception unit 308, a payment requesting unit 310, a payment result reception unit 312, an order processing unit 314, and an order record information providing unit 316.

The functions of the above-mentioned units provided to the order receiving server 300 may be realized by a computer, which includes hardware including control means such as a CPU, storage means such as a memory, and communication means such as a communication interface for transmitting/receiving data to/from the external device, reading a program stored in a computer-readable information storage medium to execute the program. Note that, the program may be provided to the order receiving server 300 via the information storage medium such as an optical disc, a magnetic disk, a magnetic tape, a magneto-optical disk, or a flash memory, or maybe provided via the data communication network such as the Internet to the order receiving server 300.

The user information storage unit 302 stores account information on the user. FIG. 15 shows an example of a user information table stored in the user information storage unit 302. In the example of the user information table shown in FIG. 15, the user ID, the password, the user's email address, the user's date of birth, and the user's sex are stored in association with one another. It should be understood that information to be stored in the user information table is not limited to that of the above-mentioned example.

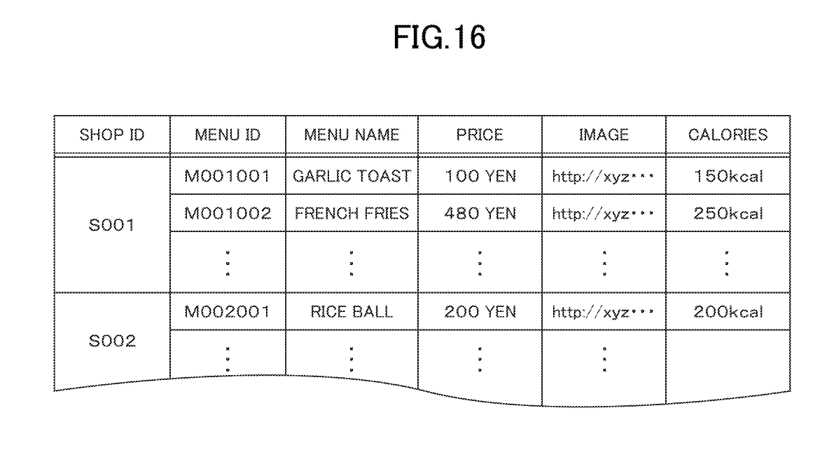

The menu information storage unit 304 stores the menu information provided by one shop or provided by each of a plurality of shops. FIG. 16 shows an example of a menu information table stored in the menu information storage unit 304. In the menu information table shown in FIG. 16, information on the respective menus served by the shop is stored for each shop ID for identifying the shop. Note that, the information on the menus includes the menu ID, a menu name, a price, an image (URL), and a calorie change amount, but the present invention is not limited thereto.

The menu information providing unit 306 provides to the mobile terminal 200 the menu information stored in the menu information storage unit 304 that is associated with the shop ID requested by the mobile terminal 200. Moreover, along with the menu information, the menu information providing unit 306 may provide to the mobile terminal 200 the application for placing the order based on the menu information.

The order information reception unit 308 receives the order information transmitted from the order information transmission unit 208 of the mobile terminal 200. For example, the order information includes the user ID, the menu ID, the order quantity, the shop ID, and the table identification information for identifying the table of the user, but the present invention is not limited thereto.

The payment requesting unit 310 requests the payment server 400 to execute the payment on the order information received by the order information reception unit 308. For example, the payment requesting unit 310 assigns the order ID for identifying the order information to each piece of order information received by the order information reception unit 308, and then calculates the payment amount relating to the order information. The payment amount may be calculated by obtaining a total of amounts of money each obtained by multiplying the price associated with the menu ID stored in the menu information storage unit 304 by the order quantity. In addition, the payment requesting unit 310 transmits to the payment server 400 the payment request information including, for example, the order ID, the order information, the payment amount, and the email address of the user who is to make a payment. Note that, as the above-mentioned email address, the email address stored in the user information storage unit 302 in association with the user ID included in the order information may be used.

The payment result reception unit 312 receives from the payment server 400 a result of the payment requested of the payment server 400 by the payment requesting unit 310. The result of the payment may include, for example, the order ID and a true/false value indicating the result of the payment. Note that, the value is true (T) when the payment is completed successfully, and the value is false (F) when the payment is completed unsuccessfully.

The order processing unit 314 transmits the order information for which the payment result received by the payment result reception unit 312 indicates that the payment is completed successfully to the shop terminal 600 corresponding to the shop ID relating to the order information. In the shop, the menu relating to the order information is served to the user based on the order information received by the shop terminal 600.

The order record information providing unit 316 generates the order record information on the order information processed by the order processing unit 314, and provides the generated order record information to the shop information providing server 500. The order record information includes, for example, the order ID, the user ID, the email address, the shop ID, the menu ID, the order quantity, and the order time, but the present invention is not limited thereto.

[Functions of Payment Server 400]

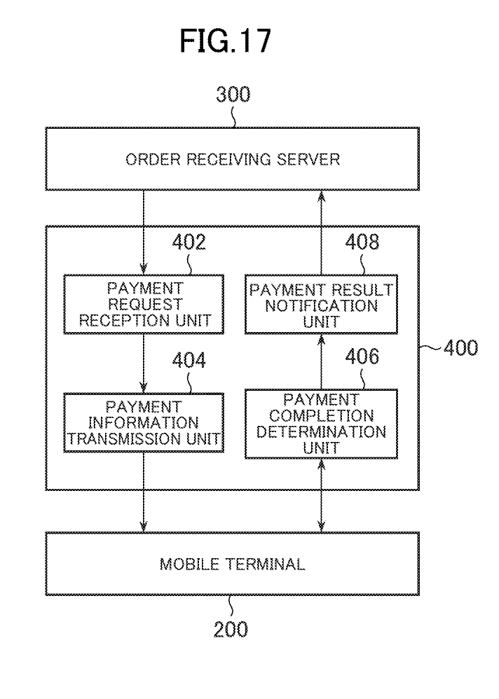

Next, a description is given of functions provided to the payment server 400. FIG. 17 illustrates a functional block diagram of the payment server 400. As illustrated in FIG. 17, the payment server 400 includes a payment request reception unit 402, a payment information transmission unit 404, a payment completion determination unit 406, and a payment result notification unit 408.

The functions of the above-mentioned units provided to the payment server 400 may be realized by a computer, which includes hardware including control means such as a CPU, storage means such as a memory, and communication means such as a communication interface for transmitting/receiving data to/from the external device, reading a program stored in a computer-readable information storage medium to execute the program. Note that, the program may be provided to the payment server 400 via the information storage medium such as an optical disc, a magnetic disk, a magnetic tape, a magneto-optical disk, or a flash memory, or may be provided via the data communication network such as the Internet to the payment server 400.

The payment request reception unit 402 receives a payment request from the order receiving server 300. To be specific, the payment request reception unit 402 receives the payment request information transmitted by the payment requesting unit 310 of the order receiving server 300. Note that, the payment request information includes, for example, the order ID, the order information, the payment amount, and the email address, but the present invention is not limited thereto.

The payment information transmission unit 404 transmits the payment start email, which is generated based on the payment request information received by the payment request reception unit 402, to the email address included in the payment request information. The payment start email includes, for example, a payment ID, the details of the order based on the order information, and the payment amount, but the present invention is not limited thereto. Note that, the payment server 400 may store the order ID corresponding to the payment ID in association with each other.

The payment completion determination unit 406 determines whether or not the electronic payment has been made successfully by the mobile terminal 200 based on the payment start email transmitted by the payment information transmission unit 404. For example, the payment completion determination unit 406 may determine whether or not the payment is completed successfully based on the payment ID, an ID of the electronic money used for the electronic payment, and information on whether or not the payment has been made successfully that are received from the mobile terminal 200.

The payment result notification unit 408 notifies the order receiving server 300 of a result of the determination made by the payment completion determination unit 406. To be specific, the payment result notification unit 408 may notify the order receiving server 300 of the order ID stored in association with the payment ID and a payment result for the payment ID (whose value is, for example, true when the payment is completed successfully and false when the error occurs).

[Functions of Shop Information Providing Server 500]

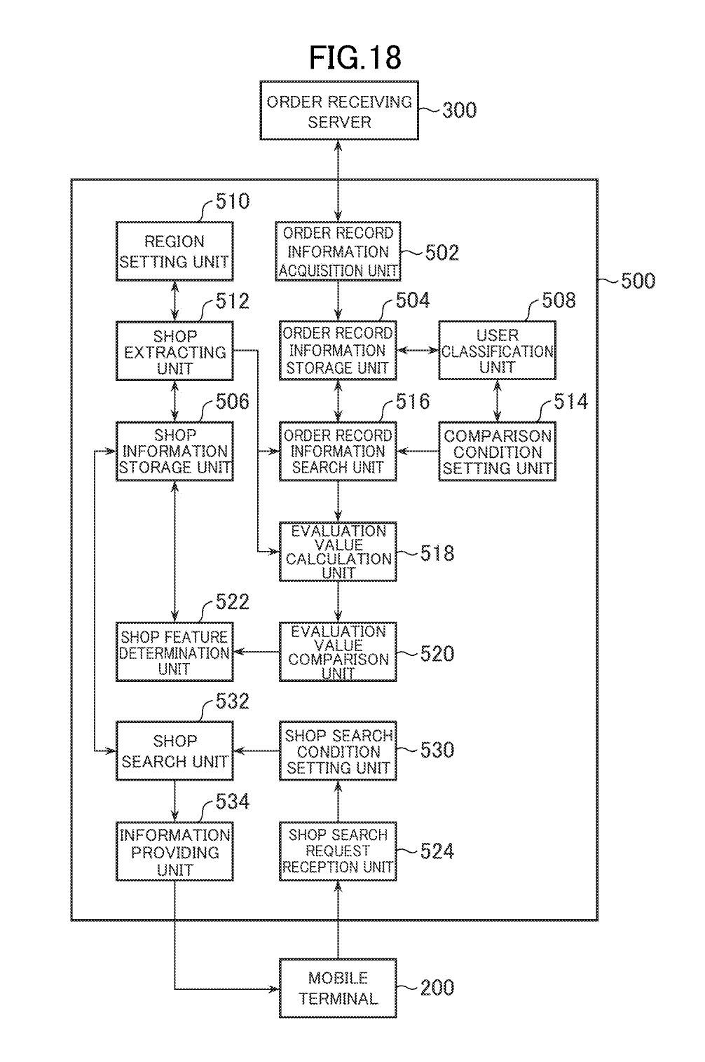

Next, a description is given of functions provided to the shop information providing server 500. FIG. 18 illustrates a functional block diagram of the shop information providing server 500. As illustrated in FIG. 18, the shop information providing server 500 includes an order record information acquisition unit 502, an order record information storage unit 504, a shop information storage unit 506, a user classification unit 508, a region setting unit 510, a shop extracting unit 512, a comparison condition setting unit 514, an order record information search unit 516, an evaluation value calculation unit 518, an evaluation value comparison unit 520, a shop feature determination unit 522, a shop search request reception unit 524, a shop search condition setting unit 530, a shop search unit 532, and an information providing unit 534.

The functions of the above-mentioned units provided to the shop information providing server 500 may be realized by a computer, which includes hardware including control means such as a CPU, storage means such as a memory, and communication means such as a communication interface for transmitting/receiving data to/from the external device, reading a program stored in a computer-readable information storage medium to execute the program. Note that, the program may be provided to the shop information providing server 500 via the information storage medium such as an optical disc, a magnetic disk, a magnetic tape, a magneto-optical disk, or a flash memory, or may be provided via the data communication network such as the Internet to the shop information providing server 500.

The order record information acquisition unit 502 acquires the order record information provided from the order record information providing unit 316 of the order receiving server 300. Note that, the order record information acquisition unit 502 may regularly request the order receiving server 300 to provide the order record information. The order record information includes, for example, the order ID, the user ID, user attribute information (age and sex), the shop ID, the menu ID, the order quantity, the payment amount, menu attribute information (calories), and the order time, but the present invention is not limited thereto.

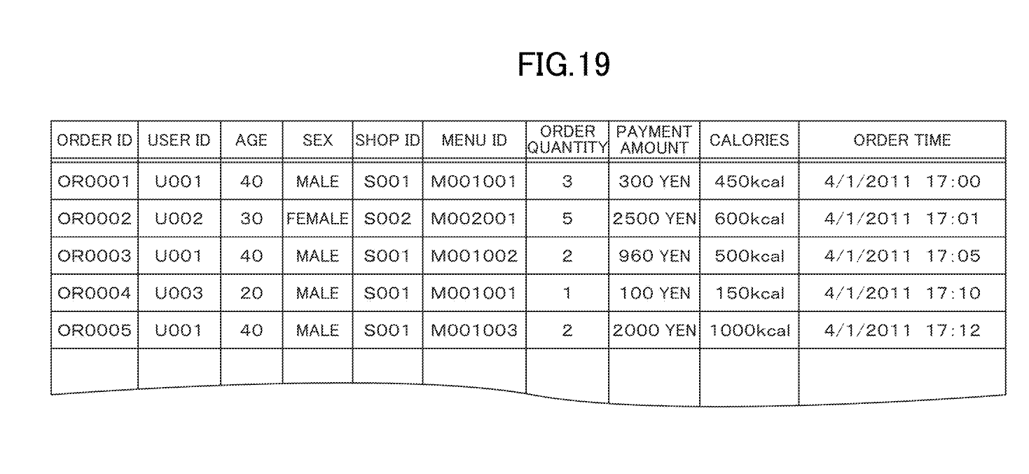

The order record information storage unit 504 stores the order record information acquired by the order record information acquisition unit 502. FIG. 19 shows an example of an order history table stored in the order record information storage unit 504. In the example of the order history table shown in FIG. 19, the order ID, the user ID, the user's age, the user's sex, the shop ID, the menu ID, the order quantity, the payment amount, the calories (total calories relating to the corresponding order), and the order time are stored, but the present invention is not limited thereto.

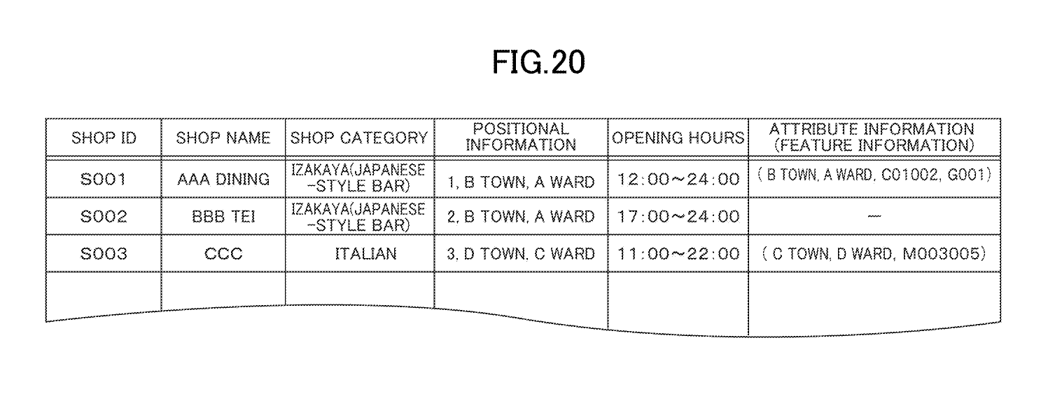

The shop information storage unit 506 stores information on each of the plurality of shops. FIG. 20 shows an example of a shop feature information table stored in the shop information storage unit 506. In the example of the shop feature information table shown in FIG. 20, the shop ID for identifying the shop, a shop name, a shop category, positional information on the shop (such as address information or latitude/longitude information), opening hours of the shop, and the attribute information (feature information) assigned as a feature of the shop are stored, but the present invention is not limited thereto. Note that, the attribute information assigned as the feature of the shop may include area information, menu/menu category information (menu/menu category ID), and the user attribute information (group ID).

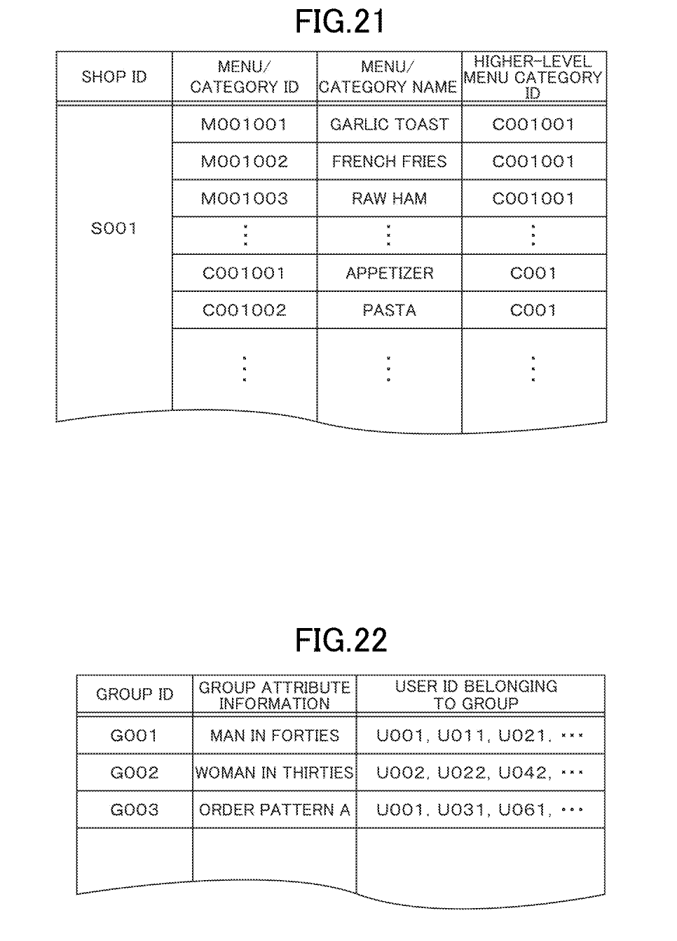

Further, the shop information storage unit 506 stores, for example, a menu information table shown in FIG. 21 storing information on the served menus for each shop. As shown in FIG. 21, in the menu information table, the shop ID, the menu/menu category ID, a menu/menu category name, and a higher-level menu category ID to which the menu/menu category ID belongs are stored, but the present invention is not limited thereto.

Based on the order record information stored in the order record information storage unit 504, the user classification unit 508 classifies a plurality of user IDs included in the stored order record information into groups. For example, the user classification unit 508 may classify the plurality of user IDs into the groups based on the age and the sex, or may classify the plurality of user IDs into the groups based on a result of clustering processing that is based on an order pattern of the plurality of user IDs (for example, a combination of order IDs).

FIG. 22 shows an example of a user classification information table storing a result of the classification performed by the user classification unit 508. In the user classification information table shown in FIG. 22, information on the group ID for identifying the group, group attribute information, and the user IDs of the users belonging to the group is stored, but the present invention is not limited thereto. Note that, when the group is formed based on the age and the sex, information on the age and the sex (for example, thirties, male, etc.) may be stored as the group attribute information, and when the group is formed based on the order pattern, information on the order pattern may be stored as the group attribute information.

The region setting unit 510 sets one or a plurality of regions (local areas) in the target area. For example, the region setting unit 510 may set the regions based on the address information on the target area (for example, set the regions based on a ward or town), or may set the regions based on a coordinate range of the target area (for example, set the regions by dividing the target area into a plurality of regions). Moreover, the region setting unit 510 may acquire a shop count included in each of the set regions based on the shop information storage unit 506, and reset the regions so as to narrow the region when the shop count is larger than a predetermined numerical range and widen the region when the shop count is smaller than the predetermined numerical range.

The shop extracting unit 512 extracts the shop satisfying a predetermined condition for the one region or for each of the plurality of regions set by the region setting unit 510. The predetermined condition in this case may be, for example, a condition that the shop belongs to a predetermined shop category (such as a Japanese-food restaurant, a Chinese-food restaurant, or an Italian-food restaurant). In addition, the shop extracting unit 512 may extract, for each of the regions set by the region setting unit 510, an appropriate shop from the shop information storage unit 506 based on the positional information (such as the address information) on the region and the predetermined shop category. In the following, a description is given of processing of detecting the feature of the shop included in one region (target region) set by the region setting unit 510, but other regions may be processed in the same manner.

The comparison condition setting unit 514 sets, for the target region, comparison conditions to be used for comparing the plurality of shops extracted by the shop extracting unit 512 with one another. For example, the comparison condition setting unit 514 sets a menu/menu category to be used for comparison, a user attribute to be used for comparison (such as the group ID), and a period to be used for comparison (target period) as the comparison conditions, but the user attribute to be used for comparison and the target period may not be included in the comparison conditions. The comparison condition setting unit 514 in this case may refer to the shop information storage unit 506 to select the menu/menu category to be used for comparison from among the menus/menu categories served by the shop extracted by the shop extracting unit 512.

The order record information search unit 516 searches the order record information storage unit 504 for the order record information satisfying the comparison conditions set by the comparison condition setting unit 514 for each of the plurality of shops extracted by the shop extracting unit 512 for the target region. For example, when the menu, the group ID, and the target period are set as the comparison conditions, in order to search for the order record information satisfying the comparison conditions for the target shop, the order record information search unit 516 may search for the order record information including the shop ID of the target shop, the menu ID of the menu, any one of the user IDs belonging to the group ID, and the order time during the target period. Moreover, when the menu category, the group ID, and the target period are set as the comparison conditions, in order to search for the order record information satisfying the comparison conditions for the target shop, the order record information search unit 516 may search for the order record information including the shop ID of the target shop, any one of the menu IDs belonging to the menu category, any one of the user IDs belonging to the group ID, and the order time during the target period.

Based on the order record information retrieved for each of the plurality of shops extracted by the shop extracting unit 512 for the target region, the evaluation value calculation unit 518 calculates the evaluation value for each of the plurality of shops. For example, the evaluation value calculation unit 518 may determine a total number (order count) of pieces of the order record information retrieved for each of the shops (or the order quantities included in the order record information) as the evaluation value, or may determine an order ratio obtained by dividing the order count by the total order count of the shop as the evaluation value. Moreover, the evaluation value may be a repeat count of the same user or the like, or may be calculated based on a combination of the order count, the order ratio, and the repeat count.

The evaluation value comparison unit 520 compares the evaluation values of the respective shops extracted from the target region, which are calculated by the evaluation value calculation unit 518, with one another. For example, based on the evaluation value calculated for each of the shops, the evaluation value comparison unit 520 may calculate the deviation value of the shop. Alternatively, the evaluation value comparison unit 520 may calculate a difference from an average value of the evaluation values of the respective shops.

Based on a result of the comparison made by the evaluation value comparison unit 520, the shop feature determination unit 522 determines whether or not each of the shops extracted in the target region has the feature in the menu/menu category and the user attribute relating to the comparison conditions set by the comparison condition setting unit 514. For example, when there is a shop whose deviation value (or whose difference from the average value) calculated by the evaluation value comparison unit 520 for each of the shops is the threshold value or larger (or larger than the threshold value), the shop feature determination unit 522 determines that the shop has the feature in the menu/menu category and the user attribute (the group ID) relating to the comparison conditions. The shop feature determination unit 522 then stores, in association with the shop determined as having the feature in the menu/menu category and the user attribute, the attribute information including information on the menu/menu category, the user attribute, and the target region in the shop information storage unit 506.

The processing of the order record information search unit 516, the evaluation value calculation unit 518, the evaluation value comparison unit 520, and the shop feature determination unit 522 may be executed on the respective comparison conditions having different combinations of the menu/menu category and the user attribute changed by the comparison condition setting unit 514.

The shop search request reception unit 524 receives the shop search queries from the user terminal such as the mobile terminal 200. For example, when receiving a shop search request, the shop search request reception unit 524 may receive a desired area and menu/menu category specified from the user terminal, or may receive keywords about a desired area and shop from the user terminal.

The shop search condition setting unit 530 sets a shop search condition based on the shop search queries received by the shop search request reception unit 524. For example, the shop search condition setting unit 530 may set the shop search condition including at least one of an area condition, a menu/menu category condition, and a user attribute condition based on the shop search queries received from the user terminal. In this case, the area condition may be set based on the specification by the shop search queries or may be the keyword included in the shop search queries. Alternatively, when the positional information on the user terminal can be acquired, the area condition may be set based on the positional information. Further, the menu/menu category condition may be set based on the specification by the shop search queries or the keyword included in the shop search queries. Moreover, the user attribute condition may be set based on the specification by the shop search queries or the keyword included in the shop search queries. Alternatively, the group IDs to which the user ID belongs may be acquired based on the user ID identified for the user terminal, and any one of the acquired group IDs may be set as the user attribute condition.

The shop search unit 532 searches the shop information storage unit 506 for the shop based on the shop search condition set by the shop search condition setting unit 530. For example, the shop search unit 532 may search the shop feature information table for the shop ID assigned with the attribute information satisfying the area condition (such as a condition for the area ID), the menu/menu category condition (such as a condition for the menu/menu category ID), and the user attribute condition (such as a condition for the group ID) that are specified in the shop search conditions.

The information providing unit 534 provides the information on the shop retrieved by the shop search unit 532 to the user terminal from which the shop search queries are received. For example, the shop information to be provided by the information providing unit 534 may include the feature information (the menu/menu category and the user attribute condition) based on the attribute information set to the retrieved shop. Moreover, the information providing unit 534 may add, to the information on the shop specified by the user terminal, the feature information based on the attribute information on the shop and provide the obtained information.

According to the shop information processing system described above, the pieces of order record information extracted by using the same condition for the respective shops included in the set local area are compared with one another, and hence useful features can be assigned to the respective shops. The features thus assigned to the shops are based on the order records, and hence those features are more reliable than features reported by the shop by itself. In addition, by using the features assigned to the shops to search for the shop, the feature of the shop can be reflected to the search result.

Further, the present invention is not limited to the embodiment described above. For example, the restaurant is applied to the description of the embodiment given above, but the shop other than the restaurant is applicable to the present invention.

Further, in the embodiment described above, the user's information is stored in the order receiving server 300, but the user's information (his/her name, age, sex, and the like) may be stored in the payment server 400 in association with the ID of the electronic money, and the user's information may be determined based on the ID of the electronic money used at the time of payment.

Further, in the embodiment described above, the order receiving server 300 acquires the user's order information from the mobile terminal 200, but the order receiving server 300 may acquire the user's order information from the shop terminal 600.

The invention claimed is:

1. An information processing system, comprising:
extracting means for extracting, from shop information storage means for storing a location of a shop in association with shop identification information for identifying the shop, a plurality of pieces of the shop identification information indicating the shops located in a given region;
order record information acquisition means for acquiring, from order record information storage means for storing order record information including the shop identification information, product identification information for identifying a product ordered in the shop indicated by the shop identification information, and an order quantity of the product, a plurality of pieces of the order record information associated with the plurality of pieces of the shop identification information extracted by the extracting means; and
setting means for identifying the shop identification information of the shop having an evaluation value based on the plurality of pieces of the order record information acquired by the order record information acquisition means,
wherein the evaluation value represents a magnitude of the order quantity of one or a plurality of the products common in a product classification, relatively larger than the evaluation values of other shops located in the given region, and the setting means sets information on the product classification as attribute information on the shop in association with the identified shop identification information.

2. The information processing system according to claim 1,
wherein the order record information comprises information on a user relating to the order record information,
wherein the order record information acquisition means acquires, from the order record information storage means, the plurality of pieces of the order record information that are associated with the plurality of pieces of the shop identification information extracted by the extracting means, and are common in the information on the user, and
wherein the setting means identifies, based on the plurality of pieces of the order record information acquired by the order record information acquisition means, the shop identification information of the shop having the evaluation value, which represents the magnitude of the order quantity of the one or the plurality of the products common in the product classification, relatively larger than the evaluation values of the other shops located in the given region, and sets the information on the product classification and the information on the user as the attribute information on the shop in association with the identified shop identification information.

3. The information processing system according to claim 1, further comprising:
search means for searching the plurality of pieces of the shop identification information located in a position of a user terminal or in a region set by a specification for the shop identification information having the information on the product classification, which is identified based on a search query received from the user terminal, set as the attribute information; and
providing means for providing the user terminal with information on the shop identified by the shop identification information retrieved by the search means.

4. The information processing system according to claim 2, further comprising:
search means for searching the plurality of pieces of the shop identification information located in a position of a user terminal or in a region set by a specification for the shop identification information having the information on the product classification, which is identified based on a search query received from the user terminal, and information on a user relating the user terminal, set as the attribute information; and
providing means for providing the user terminal with information on the shop identified by the shop identification information retrieved by the search means.

5. The information processing system according to claim 1, further comprising:
providing means for providing, when an information providing request for requesting information on the shop is received from a user terminal, the information on the shop by adding thereto the information on the product classification set by the setting means in association with the shop identification information of the shop.

6. The information processing system according to claim 1, further comprising:
changing means for changing a size of the given region based on a number of the plurality of pieces of the shop identification information extracted by the extracting means.

7. The information processing system according to claim 1, further comprising:
changing means for changing a size of the given region when the attribute information is not set by the setting means to a predetermined number or predetermined ratio of pieces of the shop identification information among the plurality of pieces of the shop identification information extracted by the extracting means.

8. The information processing system according to claim 1, further comprising:
calculating means for calculating a deviation value of the order quantity of the one or the plurality of the products common in the product classification ordered in the each of the shops based on the plurality of pieces of the order record information acquired by the order record information acquisition means, for each of the shops located in the given region,
wherein the setting means sets the information on the product classification as the attribute information to the shop having the deviation value calculated by the calculating means that is a predetermined value or larger, or larger than the predetermined value.

9. The information processing system according to claim 1, further comprising:
calculating means for calculating an average value of the order quantity of the one or the plurality of the products common in the product classification ordered in a plurality of the shops located in the given region based on the plurality of pieces of the order record information acquired by the order record information acquisition means,
wherein the setting means sets the information on the product classification as the attribute information to the shop having the order quantity of the one or the plurality of the products common in the product classification that is larger than the average value calculated by the calculating means by a predetermined value or larger, or by a value larger than the predetermined value.

10. The information processing system according to claim 1,
wherein the evaluation value representing the magnitude of the order quantity of the one or the plurality of the products common in the product classification is calculated based on any one of the order quantity of the one or the plurality of the products,
a ratio of the order quantity of the one or the plurality of the products to a total of the order quantity received by the shop, and an order repeat count of the same user of the one or the plurality of the products, or based on a combination thereof.

11. An information processing method, comprising:
an extracting step of extracting, from shop information storage means for storing a location of a shop in association with shop identification information for identifying the shop, a plurality of pieces of the shop identification information indicating the shops located in a given region;
an order record information acquisition step of acquiring, from order record information storage means for storing order record information including the shop identification information, product identification information for identifying a product ordered in the shop indicated by the shop identification information, and an order quantity of the product, a plurality of pieces of the order record information associated with the plurality of pieces of the shop identification information extracted in the extracting step; and
a setting step of identifying the shop identification information of the shop having an evaluation value based on the plurality of pieces of the order record information acquired in the order record information acquisition step,
wherein the evaluation value represents a magnitude of the order quantity of one or a plurality of the products common in a product classification, relatively larger than the evaluation values of other shops located in the given region, and in the setting step information on the product classification is set as attribute information on the shop in association with the identified shop identification information.

12. (canceled)

13. (canceled)

14. The information processing system according to claim 2, further comprising:
search means for searching the plurality of pieces of the shop identification information located in a position of a user terminal or in a region set by a specification for the shop identified based on a search query received from the user terminal, set as the attribute information; and
providing means for providing the user terminal with information on the shop identified by the shop identification information retrieved by the search means.

15. The information processing system according to claim 2, further comprising:
changing means for changing a size of the given region based on a number of the plurality of pieces of the shop identification information extracted by the extracting means.

16. The information processing system according to claim 2, further comprising:
changing means for changing a size of the given region when the attribute information is not set by the setting means to a predetermined number or predetermined ratio of pieces of the shop identification information among the plurality of pieces of the shop identification information extracted by the extracting means.

17. The information processing system according to claim 2, further comprising:
calculating means for calculating a deviation value of the order quantity of the one or the plurality of the products common in the product classification ordered in the each of the shops based on the plurality of pieces of the order record information acquired by the order record information acquisition means, for each of the shops located in the given region,
wherein the setting means sets the information on the product classification as the attribute information to the shop having the deviation value calculated by the calculating means that is a predetermined value or larger, or larger than the predetermined value.

18. The information processing system according to claim 2, further comprising:
calculating means for calculating an average value of the order quantity of the one or the plurality of the products common in the product classification ordered in a plurality of the shops located in the given region based on the plurality of pieces of the order record information acquired by the order record information acquisition means,
wherein the setting means sets the information on the product classification as the attribute information to the shop having the order quantity of the one or the plurality of the products common in the product classification that is larger than the average value calculated by the calculating means by a predetermined value or larger, or by a value larger than the predetermined value.

19. The information processing system according to claim 2,
wherein the evaluation value representing the magnitude of the order quantity of the one or the plurality of the products common in the product classification is calculated based on any one of the order quantity of the one or the plurality of the products, a ratio of the order quantity of the one or the plurality of the products to a total of the order quantity received by the shop, and an order repeat count of the same user of the one or the plurality of the products, or based on a combination thereof.
